(19) United States
(12) Patent Application Publication
(10) Pub. No.: US 2006/0032744 A1
(43) Pub. Date: Feb. 16, 2006

(54) Lambda probe

(75) Inventors: Michael-Rainer Busch, Ebersbach (DE); Patrick Hawig, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/111,772

(22) Filed: Apr. 22, 2005

(30) Foreign Application Priority Data
Apr. 24, 2004 (DE) 10 2004 020 139.0

(51) Int. Cl. G01N 27/26

(52) U.S. Cl. 204/424

(57) ABSTRACT

A lambda probe for an internal combustion engine for the measurement of the fuel-air ratio in the exhaust gas stream of the internal combustion engine is proposed, in which the portion of the oxygen sensor element reaching into the exhaust gas stream is surrounded by a protective element for trapping condensate water. The lambda probe thus constructed can be placed in operation before or immediately after the starting of the internal combustion engine, since the danger of the striking of cold condensate water against the oxygen sensor element and the damage to the lambda probe, which this entails, is prevented.

### BACKGROUND AND SUMMARY OF THE INVENTION

This application claims the priority of German Patent Document No. 10 2004 020 139.0, filed Apr. 24, 2004, the disclosure of which is expressly incorporated by reference herein.

The invention relates to a lambda probe.

It is known to reduce the pollutant concentration in the exhaust gases of motor vehicles by detecting the oxygen concentration in the exhaust gas stream of the internal combustion engine of the motor vehicle by means of a so-called lambda probe and to control the amounts of air and fuel fed to the internal combustion engine on the basis of the detected fuel-air ratio (lambda value 8). As represented greatly simplified in FIG. 4, the lambda probe is installed in an exhaust cleaning system ahead of the catalyst 12 at an exhaust tube 14 such that an oxygen sensor element of the lambda probe 10 extends into the exhaust gas stream 16 in the exhaust tube in order to measure the air-fuel ratio 8 in the exhaust gas stream. The construction and the operation of such a conventional lambda probe 10 have long been known to the practitioner of the art.

It is furthermore known, for example from DE 100 20 913 A1 to provide the lambda probe with a heating element which actively heats the ceramic coating of the oxygen sensor element of the lambda probe in order to make the lambda probe able to operate as short a time as possible after the internal combustion engine is started.

Furthermore, DE 199 42 740 A1 discloses a housing in the form of a protective tube for the oxygen sensor element of such a lambda probe, which surrounds the oxygen sensor element and thus is intended to protect against mechanical stresses by pressure changes in the exhaust gas tube. To assure the functionality of the oxygen sensor element, such a protective tube has a plurality of through-openings for the exhaust gas stream.

A known problem of conventional lambda probes is the danger of damage to the lambda probe by condensation moisture in the exhaust gas stream and exhaust tube. At the starting of an internal combustion engine, directly after the start precipitating condensate must be expected, which precipitates on the exhaust tube walls of the exhaust gas cleaning apparatus, in the form of droplets and can be again entrained by the exhaust gas stream. Thus the oxygen sensor element can be exposed not only to the exhaust gas but also to (cold) water droplets. If these condensate droplets strike a heated ceramic coating of the oxygen sensor element, thermal stresses can occur at points and can lead to fractural and crack structures in the ceramic coating.

To avoid this problem the lambda sensors are usually not placed in operation until the dew point is reached in the exhaust gas stream and accordingly no more water can condense out of the exhaust gas and thus destroy the ceramic coating of the oxygen sensor element. Due to the thus delayed activation of the lambda probe, there is a phase after the starting of the internal combustion engine, in which the oxygen content of the exhaust gas stream cannot be measured. Various functionalities which access the signal of the lambda probe, as for example lambda control, secondary air diagnosis, warm-up control and the like, are therefore unavailable directly after the internal combustion engine is started.

The present invention is therefore addressed to the problem of providing a lambda probe for an internal combustion engine, which can be put in operation before or immediately after the internal combustion engine is stated, without danger of damage by moisture condensation.

This problem is solved by a lambda probe for an internal combustion engine. Advantageous embodiments and further developments of the invention are described herein below.

In the lambda probe according to the invention, for measuring the fuel-air ratio in the exhaust stream of an internal combustion engine with an oxygen sensor element, the portion of the oxygen sensor element extending into the exhaust stream is surrounded by a protective element for trapping condensation moisture even before or immediately after the starting of the internal combustion engine, since any condensate moisture that may be entrained in the exhaust gas stream will not strike the oxygen sensor element and therefore it cannot be damaged. Since any possible damage to the oxygen sensor element by impinging condensate is effectively prevented, it is possible to place the lambda probe in operation before or directly after the internal combustion engine is started, and thus to make the special functionalities of the exhaust gas cleaning system available very early.

The protective element can be, for example, a sintered metal filter or a metal fleece, and such a protective element can be arranged either at a distance from or substantially without a gap between it and the oxygen sensor element.

In a preferred embodiment of the invention the protective element has an electrical heating element in order to be able actively to evaporate the condensate trapped in the protective element.

The protective element can be connected to the lambda probe, or more precisely to the mounting base of the lambda probe on the exhaust gas pipe by pressing, welding, soldering, cementing or the like.

In further embodiment of the invention, the oxygen sensor element also contains an integrated heating element in order to be able actively to head the oxygen sensor element to the necessary operating temperature.

Other objects, advantages and novel features of the present invention will become apparent from the following detailed description of the invention when considered in conjunction with the accompanying drawings.

### BRIEF DESCRIPTION OF THE DRAWINGS

FIG. 1A shows a schematic cross-section of the parts of the oxygen sensor element of a lambda probe reaching into the exhaust gas stream according to a first embodiment of the invention,

FIG. 1B a schematic longitudinal section of the parts of the oxygen sensor element of the lambda probe of FIG. 1 which reach into the exhaust gas stream,

FIG. 2A a schematic cross section of the parts of the oxygen sensor element of the lambda probe that reach into the exhaust gas stream according to a second embodiment of the invention,

FIG. 2B a schematic cross section of the parts of the oxygen sensor element of the lambda probe of FIG. 2a which reach into the exhaust gas stream,

FIG. 3 a schematic cross section of the parts of the oxygen sensor element of the lambda probe which reach into the exhaust gas stream in a third embodiment of the invention, and

FIG. 4 a schematic representation of a section of an exhaust gas cleaning apparatus of an internal combustion engine with a built-in lambds probe.

### DETAILED DESCRIPTION OF THE DRAWINGS

As represented in FIG. 4, the lambda probe 10 is mounted in an exhaust gas cleaning apparatus of an internal combustion engine of a motor vehicle, usually ahead of the catalyst 12 on the exhaust gas tube 14. In this case a portion of the oxygen sensor element of the lambda probe 10 extends into the exhaust ga stream 16 in the exhaust gas tube 14. Since the manner of operation of such lambda probes has long been known to the expert, no further description thereof will be given in the scope of this description.

It is, however, expressly pointed out at this point that the present invention is not limited to any special construction or special manner of operation of a lambda probe, but exclusively concerns the arrangement of a protective element described hereinafter for such a lambda probe. The present invention is especially advantageous on the basis that even existing lambda probes can be equipped according to the invention. Furthermore, it is pointed out that the lambda probe of the present invention is usable especially both for Otto-cycle engines and for Diesel engines.

A first embodiment of a lambda probe according to the present will now be first explained, the two figures showing only the portion of an oxygen sensor element of the lambda probe 10 which reach into the exhaust gas stream 16. The remaining part of the lambda probe has long been known to the expert and will not be further explained at this point.

For protection against mechanical stresses by pressure changes in the exhaust pipe 14, the centrally arranged oxygen sensor element 18 of known construction is surrounded by a protective tube 20, which is provided with through-openings (not represented) so that the exhaust stream 16 can come in contact with the surface of the oxygen sensor element 18. Such a protective tube is known, for example, from DE 199 42 740 A1 previously mentioned in the beginning, but the invention, of course, is not limited just to the embodiment of a protective tube therein disclosed.

Between this protective tube 20 and the central oxygen sensor element 18, a protective element 22 is arranged according to the invention, while between the external protective tube 20 and the protective element 22 an isolation gap 24 is provided, and between the central oxygen sensor element 18 and the protective element 22 a heat transition gap 26 is provided.

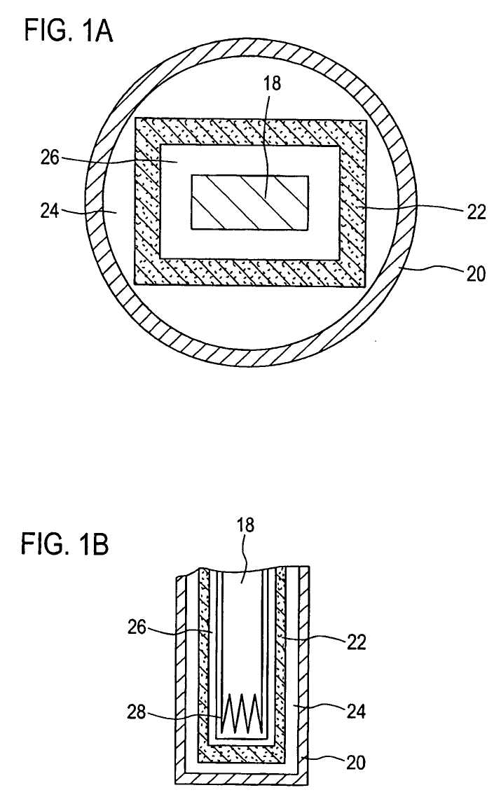

The protective element 22 is a sintered metal filter in the first embodiment in FIGS. 1A and 1B. The size and profile of this sintered metal filter are adapted according to the size and shape of oxygen sensor element 18 and protective tube 20. In particular, the protective element 22 can have the shape of a round or rectangular cylinder.

The sintered metal filter 22 has a porousness of, foe example, about 10:m to 120:m and is able to collect condensate moisture carried in the exhaust stream 16, i.e., to prevent the impact of the condensate moisture on the oxygen sensor element 18. The permeability of the sintered metal filter 22 can be influenced by the grain size of the filter element.

The removal of the condensate moisture collected in the sintered metal filter 22 is performed by evaporating this condensate moisture. This can be done in various ways. For one way, the heat necessary for the evaporation of the condensate moisture from the sintered metal filter can be taken from the exhaust gas stream 16 or from the heated oxygen sensor element 18. In a preferred embodiment of the invention, however, it is also possible to provide the sintered metal filter 22 itself with an electrical heating element (not represented) and thus actively heat the protective element 22.

The connection (not shown) of the sintered metal filter 22 to the lambda probe 10, more precisely with a mounting base of the lambda probe 10 on the exhaust pipe 14, is performed, for example, by means of pressing, welding, soldering, cementing, or the like.

As indicated in FIG. 1B, it is furthermore possible to provide the oxygen sensor element 18 with its own integrated heating element 28. In this way the oxygen sensor element 18 is actively heated in order the more quickly to reach its required operating temperature, as is already basically known in the state of the art.

With the above-described construction of the lambda probe 10 it is simply possible to prevent condensation moisture entrained in the exhaust gas stream from reaching the portion of the oxygen sensor element 18 that reaches into the exhaust gas stream and damage it. It is therefore possible to put this lambda probe 10 into operation just before or immediately after the starting of the internal combustion engine and thus to make available other functionalities as well, such as for example lambda control, secondary air diagnosis, warm air control and the like.

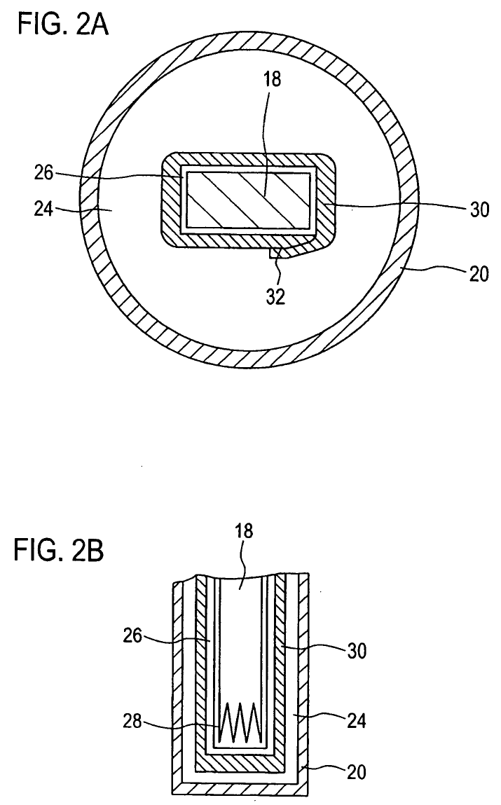

With the aid of FIGS. 2A and 2B, a second embodiment of a lambda probe 10 according to the invention will now be explained. Equal elements will be provided with the same reference numbers as in the first embodiment; for brevity's sake no repetition of the construction and operation of these elements will be given.

The lambda probe 10 of the second embodiment differs from the one shown in FIG. 1 in the nature of the protective element. The lambda probe 10 represented in FIGS. 2A and 2B has as protective element 30 a metal fleece. As it can be seen in FIG. 2, this metal fleece is wound around the oxygen sensor element 18 with a separation 26 therefrom, and has, for example, a weld seam 32.

The permeability of the protective element 30 can in this case be affected by the density of the fleece texture. The application of the metal fleece 30 to the lambda probe 10 and the manner of operation of the metal fleece 30 are the same as in the sintered metal filter 22 of the first embodiment. In particular, a heating element (not represented) can also be integrated into the metal fleece so as to be able to heat the metal fleece actively to evaporate the condensate moisture collected therein.

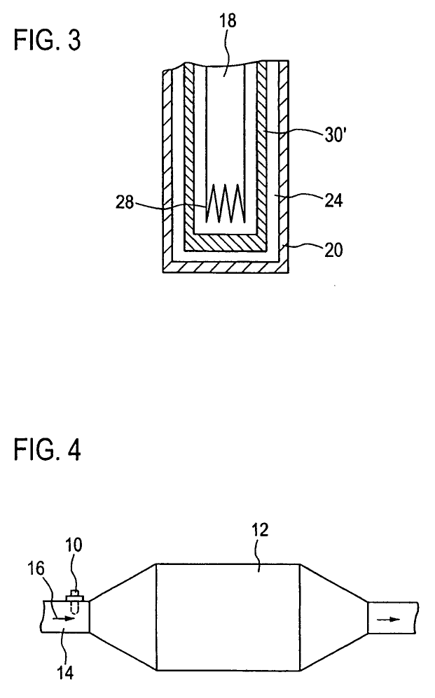

While in the second embodiment of FIGS. 2A and 2B a gap 26 is provided between the central oxygen sensor element 18 and the metal fleece 30, it is also possible to wind the metal fleece 30′ around the central oxygen sensor element substantially without any space, as this is represented in the drawing of a third embodiment in FIG. 3.

The effects and advantages of the lambda probes 10 of the second and third embodiment are the same as in the first embodiment.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Lambda probe for an internal combustion engine for measuring the fuel-air ratio in the exhaust gas stream of the internal combustion engine, having an oxygen sensor element, characterized in that the part of the oxygen sensor element that reaches into the exhaust gas stream is surrounded by a protective element to trap condensation water.

2. Lambda probe according to claim 1, wherein the part of the oxygen sensor element that reaches into the exhaust gas stream is furthermore surrounded by a protective tube having through-opening for the exhaust gas stream, and that the protective element is disposed between the oxygen sensor element and the protective tube.

3. Lambda probe according to claim 1, wherein the protective element contains a sintered metal filter.

4. Lambda probe according to claim 2, wherein the protective element contains a sintered metal filter.

5. Lambda probe according to claim 1, wherein the protective element contains a metal fleece.

6. Lambda probe according to claim 2, wherein the protective element contains a metal fleece.

7. Lambda probe according to claim 1, wherein the protective element is disposed at a distance from the oxygen sensor element.

8. Lambda probe according to claim 2, wherein the protective element is disposed at a distance from the oxygen sensor element.

9. Lambda probe according to claim 3, wherein the protective element is disposed at a distance from the oxygen sensor element.

10. Lambda probe according to claim 4, wherein the protective element is disposed at a distance from the oxygen sensor element.

11. Lambda probe according to claim 1, wherein the protective element is arranged substantially without spacing away from the oxygen sensor element.

12. Lambda probe according to claim 3, wherein the protective element is arranged substantially without spacing away from the oxygen sensor element.

13. Lambda probe according to claim 3, wherein the protective element is arranged substantially without spacing away from the oxygen sensor element.

14. Lambda probe according to claim 4, wherein the protective element is arranged substantially without spacing away from the oxygen sensor element.
